(19) United States
(12) Patent Application Publication
(10) Pub. No.: US 2011/0035091 A1
(43) Pub. Date: Feb. 10, 2011

(54) SENSOR SYSTEM FOR MOTION CONTROL OF A MOVING UNIT AND A METHOD OF INSTALLING A SENSOR SYSTEM FOR MOTION CONTROL OF A MOVING UNIT

(75) Inventor: Satoshi Yamamoto, Hitachi (JP)

Correspondence Address: BRUNDIDGE & STANGER, P.C., 2318 MILL ROAD, SUITE 1020, ALEXANDRIA, VA, 22314, US

(73) Assignee: HITACHI CABLE, LTD., Tokyo (JP)

(21) Appl. No.: 12/850,066

(22) Filed: Aug. 4, 2010

(30) Foreign Application Priority Data
Aug. 5, 2009 (JP) 2009-182281

(51) Int. Cl. G06F 7/00; B23P 11/00

(52) U.S. Cl. 701/29; 29/428

(57) ABSTRACT

A sensor system for motion control of a moving unit such as a vehicle, which is comprised of a uniaxial physical value sensor having a single detection axis and the uniaxial physical value sensor being installed in a unsprung mass of a suspension device provided in the moving unit, wherein the detection axis of the uniaxial physical value sensor and the working axis of a vibration-buffering member provided on the suspension device are approximately parallel.

The present application is based on Japanese Patent Application No. 2009-182281 filed on Aug. 5, 2009, the entire contents of which are incorporated herein by reference.

### TECHNICAL FIELD

The present invention relates to a sensor system for motion control of a moving unit such as an automobile or a rail car that has a suspension device and relates to a method of installing a sensor system for motion control of such moving unit.

### BACKGROUND ART

For improvement of driving-braking performance and quality of handling stability of a moving unit such as an automobile or a rail car that has a suspension device (hereinafter referred to as a vehicle or vehicles), such a system as controls the driving-braking of a vehicle and the steering of each of the wheels of the vehicle responding to measurements obtained by measuring the motion of the vehicle has been developed.

For example, the anti-lock braking system (ABS) and the traction control system (TCS), which work on the suppressing of wheel-lock and wheel-skid relying on wheel speed sensors that detect rotating speed of each of the wheels of a vehicle, have been popularized.

A motion control system equipped with a wheel speed sensor is shown in FIGS. 18 and 19 as an example that represents a configuration of a conventional motion control system. FIG. 18 shows the arrangement of a wheel and its vicinity in a strut type suspension system widely used as a suspension mechanism of an vehicle, or an automobile. The FIG. is a rear elevational view of the right front wheel viewed from the rear of a front wheel drive car. FIG. 19 is a partial top view to show a part of the motion control system shown in FIG. 18.

A tire 101 is installed with a tilt by the amount of the camber angle (about 1 degree) to the vertical axis (top-bottom direction) of the vehicle body to increase the stability in the straight travelling and in the cornering and is joined to the rotating portion of a hub 102 through a wheel frame (not shown). The rotating portion of the hub 102 is joined to a drive shaft 103 that transfers revolution from the engine.

The fixing portion of the hub 102 is secured (rigidly tightened) to a knuckle 104 so that they will behave like one solid body. The topside of the knuckle 104 is rigidly tightened to the bottom side of a shock absorber 105; thereby, the knuckle 104 is joined to the vehicle body (this is illustrated as a boundary wall along engine room 106 in FIG. 18) through the shock absorber 105.

At the topside of the shock absorber 105, a spring 107 is installed; thereby the dumping function rendered by the shock absorber 105 and the elastic function provided by the spring 107 moderate vertical movements of the vehicle body attributable to irregularity of the road surface or rolling or pitching during cornering. That is, the nearly-vertical movement of the shock absorber 105 along its center axis plays such a role as to moderate and converge the swinging (oscillation) caused from the characteristic of the spring 107.

One end of a lower arm 108 is joined to the bottom of the knuckle 104 using a rotatable ball joint 109 as shown in FIG. 19. The other end of the lower arm 108 is joined to a vehicle body part 110 through a rubber bushing (not shown) for buffering the movement of the lower arm 108. A tie rod 111 for turning the wheel heading (i.e., for steering) is joined to the knuckle 104. A right-left direction movement of the tie rod 111 causes the knuckle 104 to pivot around the ball joint 109 in the arrow-indicated direction shown in FIG. 19. This causes the heading of wheels of the vehicle to turn for cornering.

As mentioned above, many parts such as the spring 107, the shock absorber 105, the knuckle 104, the hub 102, a brake rotor 112, the drive shaft 103, and the tie rod 111 are accommodated between the parts of the vehicle body (the boundary wall along engine room 106, the vehicle body part 110, etc.) and the tire 101. In the present application, such a part of space as is below the position of the spring 107 in the space spreading from the car-body-side to the tire is defined as an “unsprung mass”, and such parts as are arranged within such area are referred to as “unsprung mass parts”. Where a part is partially included in the “unsprung mass”, only the included portion of the part is called the “unsprung mass part”. In the case of the shock absorber 105 for example, the portion thereof below the spring 107 is referred to as the “unsprung mass part”. Likewise, the portion thereof above the spring 107 is referred to as the “sprung mass”.

For detection of the rotating speed of the wheel (comprised of the tire 101 and a wheel frame (not shown) and the hub 102), a magnetic encoder, which has plural pairs of magnetic S-pole and N-poles arranged alternately, is provided on the periphery of the hub 102 that rotates together with the wheel as one body and a magnetic sensor (a wheel speed sensor) is installed on a non-rotating portion of the hub 102. With this configuration, the rotating speed of the wheel is detected based on the speed of variation of the output of the magnetic sensor.

A cable 114, which is connected to a sensor head 113 that comprises the wheel speed sensor, connects to a signal processing circuit (not shown) for the wheel speed sensor located in the engine room passing through the unsprung mass. Namely, the cable 114 runs via fixing portions provided at about three points at the lower part of the shock absorber 105 and on the boundary wall along engine room 106 (wherein such a fixing portion among the three points as is provided on the boundary wall along engine room 106 belongs to the sprung mass). As the cable 114 swings, the cable 114 is installed with slack so as not to be excessively tensioned.

As shown in FIG. 18, the hub 102, on which the wheel speed sensor head 113 is to be provided, is positioned close to the brake rotor 112 that includes a disc brake (not shown) equipped on the vehicle. The brake rotor 112 heats to several hundred degrees on the vehicle braking. On a continuous run, heating or heat transferring to vicinity is suppressed by the cooling effect rendered by the run. When, however, the vehicle stops immediately after the brake is applied, heat is built up and thereby the temperature around the wheel speed sensor head 113 rises. Therefore, the upper limit of operating temperature of the wheel speed sensor head 113 should consider covering high temperatures up to about 150° C.

Even in the case that the brake system provided on a car is not a disc type brake but a drum type brake, such case is the same thing as the disc type brake in that the hub 102, on which the wheel speed sensor head 113 is installed, is arranged close to the brake drum that reaches high temperature.

A system for achieving stable running at curves by suppressing under steering and over steering is also being developed, in which at least one of a single acceleration sensor, or both, for measuring a lateral acceleration and a single angular rotation speed sensor for measuring an angular rotation speed in a horizontal plane (yaw rate) has been developed as a motion control system for actualization of stabilized run with understeer or oversteer being suppressed. An example of such motion control system is the Electronic Stability Control (ESC) system, which prevents skidding (for example, see the homepage of ESC Spreading Committee: http://www.esc-jpromo-activesafety.com/about.html).

The system is a motion control system that relies on detected lateral acceleration and angular rotation speed in horizontal plane of the vehicle resulted from the reactive force from the road surface, generated as the car moves.

In a common technique, a lateral acceleration sensor, which detects lateral acceleration, and a yaw rate sensor, which detects angular rotation speed in horizontal plane are installed near the gravity center of a vehicle body, which center exists usually in the sprung mass. This configuration transmits the reactive force from the road surface to the sensors located in the sprung mass of the vehicle through tires and their suspensions, which are the unsprung mass parts that include unsprung mass of the vehicle. Therefore, information delay occurs while the reactive force from the road surface is transmitted through the unsprung mass parts; this has caused a problem in that an accurate motion control is prevented.

For avoiding this problem, it would be an idea to install sensors, which are the lateral acceleration sensor for detection of lateral acceleration and the yaw rate sensor for detection of angular rotation speed in horizontal plane, in the unsprung mass of the vehicle with the delay of detected information minimized.

As an example of the installing of sensors in the unsprung mass of a vehicle, a road surface examination apparatus for automotive use is described in for example JP2005-170242A, wherein the acceleration sensor for detection of vertical acceleration of a car is installed in both the sprung mass and the unsprung mass. In this apparatus, the acceleration sensor for the unsprung mass is installed at the bottom of the knuckle located close to the wheel.

JP2008-14327A describes a configuration in which an acceleration sensor is installed on a stationary part of a rolling bearing unit (hub) of a wheel. In this method, acceleration sensors are used to detect acceleration along 3-axis of a car: the fore-and-aft direction (the x-axis), the right-left direction (the y-axis), and the top-bottom direction (the z-axis); thereby movements of the wheel are detected in the fore-and-aft direction, the right-left direction, and the top-bottom direction.

JP2007-271005A describes a rolling bearing device having a sensor. The device has a built-in sensor installed within a rolling bearing unit (hub) on a car.

It is interpreted to mean that the following items are rigidly tightened in one body with the wheel of a car: the knuckle in the road surface examination apparatus for automotive use defined in JP2005-170242A to which the acceleration sensor is installed in the unsprung mass; the acceleration sensor defined in JP2008-14327A; and the hub defined in JP2007-271005, which is a rolling bearing unit within which the sensor is installed.

The wheel of a vehicle is installed on the vehicle usually with a camber angle, the angle of wheel in right-left direction to the axis of top-bottom direction of a vehicle. The camber angle varies by plus or minus about 10-degree depending on the movement of the vehicle such as turning. In such vehicle movement, the fixing portions of the sensors on the knuckle rigidly tightened with the wheel and on the hub, and the detection axes of the sensors vary in the right-left direction by plus or minus about 10-degree to the axis of top-bottom direction of the vehicle depending on the variation of the camber angle.

Let us deliberate a sensor as an acceleration sensor. If the detection axis of an acceleration sensor, which is installed according to the coordinate axis defined based on the standing-still state of a vehicle, moves right or left because of variation of the camber angle caused from the movement of the vehicle such as turning resulting in its positional deviation from the above-stated coordinate axis, the acceleration value detected by the acceleration sensor may have a risk of having a foreign acceleration component on a detection axis other than the desired detection axis mingled therewith. The inclusion of foreign acceleration component on an axis other than the desired detection axis invites a reduction of amount in the detected value of the acceleration component on the desired detection axis developing into such a problem that the accuracy of the acceleration detection on the desired detection axis deteriorates.

The knuckle and the hub, which are rigidly tightened in one body with the wheel, are the unsprung mass parts and they are joined with the shock absorber as shown in FIG. 18. The shock absorber is installed usually with the caster angle, which is a tilt angle in fore-and-aft direction as shown in FIG. 20. Because of these arrangements, the positional deviation of the acceleration detection axis from the coordinate axis defined based on the standing-still state of the vehicle is caused also from variation of the caster angle of the shock absorber attributable to vehicle movements.

Further to the above, the lean of the vehicle body itself in right-left or fore-and-aft direction causes the tilt status of the unsprung mass parts to vary resulting in the positional deviation of the acceleration detection axis from the coordinate axis defined based on the standing-still state of the vehicle.

As stated above, when sensors for such control system, particularly acceleration sensors, are installed on the parts in the unsprung mass such as the knuckle and the hub intending to prevent delay of the detection information generated from the sensor of the motion control system of a moving unit such as a vehicle in response to the reaction force received from the road surface, a positional fluctuation occurs on the detection axis of the sensor deviating from the coordinate axis defined based on the standing-still state of the vehicle leading to such a problem that the accuracy of the detection on the desired detection axis of the sensor deteriorates.

For actualization of accurate control of a moving unit by a motion control system, it is necessary to prevent delay of the detection information generated from the sensors used in such control system in response to the reaction force received from the road surface and further necessary to maintain the detection accuracy of the sensors on the detection axis high.

### SUMMARY OF INVENTION

The present invention provides a sensor system for motion control of a moving unit and a method of installing a sensor system for motion control of a moving unit, wherein the system is capable of preventing delay of the detection information generated in response to the reaction force received from the road surface by installing the sensors, such as acceleration sensors, in the unsprung mass of a moving unit such as a vehicle and is capable of maintaining the detection accuracy of the sensors on the detection axis high suppressing the positional fluctuation of the detection axis of the sensor caused by the movements of a vehicle deviating from the coordinate axis defined based on the standing-still state of a vehicle.

According to a first aspect of the present invention, a sensor system for motion control of a moving unit such as a vehicle is provided, comprising an uniaxial physical value sensor having a single detection axis, and the uniaxial physical value sensor being installed in the unsprung mass of a suspension device provided in the moving unit, wherein the detection axis of the uniaxial physical value sensor and the working axis of a vibration-buffering member provided on the suspension device are approximately in parallel.

According to a second aspect of the present invention, a sensor system for motion control of a moving unit such as a vehicle is provided, comprising a multi-axial physical value sensor comprising a plurality of detection axes intersecting alternately at right angles, and the multi-axial physical value sensor being installed in the unsprung mass of a suspension device provided in the moving unit, wherein one detection axis of the multi-axial physical value sensor and an axis of a vibration-buffering member motion provided on the suspension device are arranged in approximately parallel; and the other detection axes of the multi-axial physical value sensor are oriented so as to intersect the axis of a vibration-buffering member motion provided on the suspension device at approximately right angles.

According to a third aspect of the present invention, a sensor system for motion control of a moving unit is provided, wherein the physical value sensor is installed in the unsprung mass of the vibration-buffering member.

According to a fourth aspect of the present invention, a sensor system for motion control of a moving unit is provided, wherein the physical value sensor is held rigidly at the distal end of the vibration-buffering member.

According to a fifth aspect of the present invention, a sensor system for motion control of a moving unit is provided, wherein the physical value sensor is installed on the vibration-buffering member so that its detection axis intersects a manipulation axis of the moving unit.

According to a sixth aspect of the present invention, a sensor system for motion control of a moving unit is provided, wherein a plurality of the physical value sensors are installed on the moving unit, a cable provided on each of the plural physical value sensors is held on a holder provided on the vibration-buffering member, and other physical value sensors are rigidly held by the holder.

According to a seventh aspect of the present invention, a sensor system for motion control of a moving unit is provided, wherein a plurality of the physical value sensors are installed on the moving unit and the plural physical value sensors are connected by a series of cables.

According to an eighth aspect of the present invention, a sensor system for motion control of a moving unit is provided, wherein the moving unit is a vehicle; a wheel speed sensor is provided on the wheel of the vehicle for detection of the revolution number of the wheel; a cable provided on the wheel speed sensor is held on a holder provided on the vibration-buffering member; and the physical value sensor is rigidly held on the holder.

According to a ninth aspect of the present invention, a sensor system for motion control of a moving unit is provided, wherein the wheel speed sensor and the physical value sensor are connected by a series of cables.

According to a tenth aspect of the present invention, a sensor system for motion control of a moving unit is provided, wherein the physical value sensor is an acceleration sensor.

According to an eleventh aspect of the present invention, a sensor system for motion control of a moving unit is provided, wherein the physical value sensor is a load sensor.

According to a twelfth aspect of the present invention, a method of installing a sensor system for motion control of a moving unit such as a vehicle is provided, comprising: installing an uniaxial physical value sensor, comprising a single detection axis, in the unsprung mass of a suspension device provided in the moving unit, and arranging the detection axis of the uniaxial physical value sensor and an axis of a vibration-buffering member motion provided on the suspension device in approximately parallel.

According to a thirteenth aspect of the present invention, a method of installing a sensor system for motion control of a moving unit such as a vehicle is provided, comprising: installing a multi-axial physical value sensor, comprising a plurality of detection axes intersecting alternately at right angles, in an unsprung mass of a suspension device provided in the moving unit; arranging one detection axis of the multi-axial physical value sensor and an axis of a vibration-buffering member motion provided on the suspension device in approximately parallel; and orienting the other detection axes of the multi-axial physical value sensor so as to intersect the axis of the vibration-buffering member motion provided on the suspension device at approximately right angles.

According to a fourteenth aspect of the present invention, a method of installing a sensor system for motion control of a moving unit is provided, wherein the physical value sensor is installed in the unsprung mass of the vibration-buffering member.

According to a fifteenth aspect of the present invention, a method of installing a sensor system for motion control of a moving unit is provided, wherein the physical value sensor is held rigidly at the distal end of the vibration-buffering member.

According to a sixteenth aspect of the present invention, a method of installing a sensor system for motion control of a moving unit is provided, wherein the physical value sensor is arranged on the vibration-buffering member so that the detection axis of the physical value sensor intersects a manipulation axis of the moving unit.

According to a seventeenth aspect of the present invention, a method of installing a sensor system for motion control of a moving unit is provided, wherein a plurality of the physical value sensors are installed on the moving unit; holding a cable provided on each of the plural physical value sensors, which are installed on the moving unit, on a holder provided on the vibration-buffering member; and holding the other physical value sensors rigidly on the holder.

According to an eighteenth aspect of the present invention, a method of installing a sensor system for motion control of a moving unit is provided, wherein the moving unit is a vehicle; installing a wheel speed sensor on a wheel of the vehicle for detection of the revolution number of the wheel of the vehicle; holding a cable provided on the wheel speed sensor on a holder provided on the vibration-buffering member; and holding the physical value sensor rigidly on the holder.

The present invention provides superior effects as described as follows.

Since the present invention employs such a configuration that a sensor, such as an acceleration sensor, is arranged on a vibration-buffering member that is a structural element of the suspension device of a moving unit such as a vehicle, a sensor system for motion control of a moving unit and a method of installing a sensor system for motion control of a moving unit are provided, wherein the system is capable of preventing the delay of the detection information generated in response to the reaction force received from the road surface and is capable of maintaining the detection accuracy of the sensors on the detection axis high suppressing the positional fluctuation of the detection axis of the sensor caused by the movements of the vehicle deviating from the coordinate axis defined based on the standing-still state of the vehicle.

The sensor system for motion control of a moving unit of the present invention or the method of installing a sensor system for motion control of a moving unit of the present invention, or both, suppress the positional deviation of the detection axis of the sensor, such as the acceleration sensor, from the coordinate axis defined based on the standing-still state of the vehicle, to which variations in the camber angle and the caster angle caused from movements of a vehicle and variations in the lean of the vehicle itself in lateral or longitudinal direction are responsible. Thereby, it becomes practicable to suppress the degree of mingling foreign acceleration component on an axis other than the detection axis of the sensor with the detection accuracy on the detection axis of the sensor enhanced.

Further to the above, the system of the present invention prevents the delay of the detection information generated in response to the reaction force received from the road surface, since the installation method stated above arranges the sensor such as an acceleration sensor in the unsprung mass of the moving unit such as a vehicle. Therefore, a synergy with the highly accurate sensor output on the detection axis of sensor as stated above makes it possible to control movement of an automobile with high accuracy.

### BRIEF DESCRIPTION OF DRAWINGS

FIG. 1 illustrates the configuration of the sensor system for motion control of a moving unit in the embodiment 1 of the present invention. The drawing is a rear elevational view of the right front wheel viewed from the rear of a front wheel drive car.

FIG. 2 illustrates a top view of the sensor system for motion control of a moving unit in the embodiment 1 of the present invention.

FIG. 3 illustrates a side elevational view of the sensor system for motion control of a moving unit in the embodiment 1 of the present invention.

FIG. 4 illustrates a definition of the coordinate used in the present invention.

FIG. 5 illustrates an example of analysis of the output of the acceleration sensor, a physical value sensor.

FIG. 6 illustrates an example of analysis of the output of the acceleration sensor, A physical value sensor.

FIG. 7 illustrates the principle of the present invention. The drawing explains the influence of the position of the detection axis of the acceleration sensor, a physical value sensor.

FIG. 8 illustrates the configuration of the sensor system for motion control of a moving unit in the embodiment 2 of the present invention.

FIG. 9 illustrates the configuration of the sensor system for motion control of a moving unit in the embodiment 3 of the present invention. The drawing is a rear elevational view of the right front wheel viewed from the rear of a front wheel drive car.

FIG. 10 illustrates a top view of the sensor system for motion control of a moving unit in the embodiment 3 of the present invention.

FIG. 11 illustrates the configuration of the sensor system for motion control of a moving unit in the embodiment 4 of the present invention.

FIG. 12 illustrates the configuration of the sensor system for motion control of a moving unit in the embodiment 5 of the present invention.

FIG. 13 illustrates the configuration of the sensor system for motion control of a moving unit in the embodiment 6 of the present invention.

FIG. 14 illustrates the configuration of the sensor system for motion control of a moving unit in the embodiment 7 of the present invention.

FIG. 15 illustrates the modified configuration of the sensor system for motion control of a moving unit in the embodiment 7 of the present invention.

FIG. 16 illustrates the configuration of the sensor system for motion control of a moving unit in another embodiment of the present invention.

FIG. 17 illustrates the configuration of the sensor system for motion control of a moving unit in another embodiment of the present invention.

FIG. 18 illustrates the configuration of a conventional motion control system. The drawing is a rear elevational view of the right front wheel viewed from the rear of a front wheel drive car.

FIG. 19 illustrates the configuration of a conventional motion control system. The drawing is a top view of a part of FIG. 18.

FIG. 20 illustrates the configuration of a conventional moving unit. The drawing is a side elevational view of a shock absorber and related arrangement.

### DESCRIPTION OF EMBODIMENTS

The following will describe embodiments of the present invention with reference to the drawings.

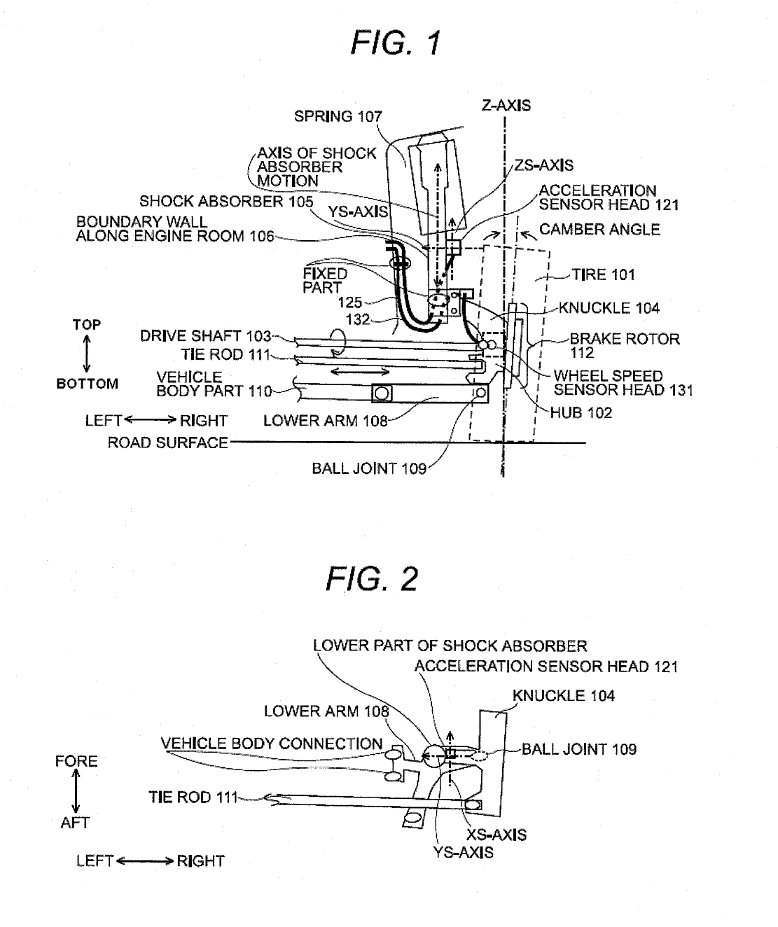

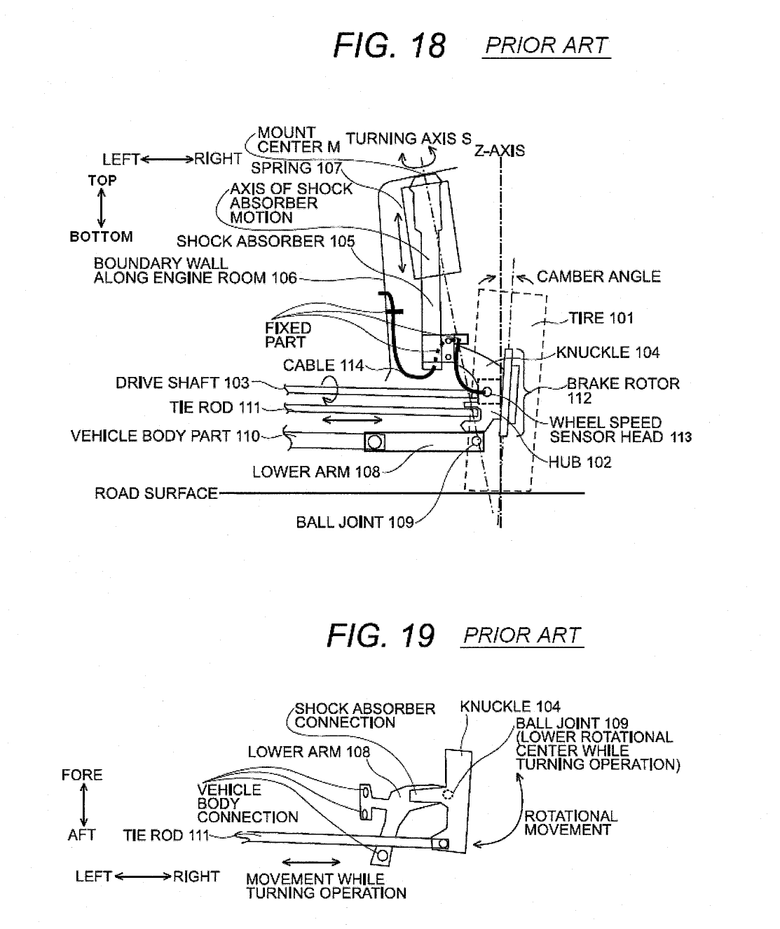

A first embodiment of the present invention will be explained with reference to FIGS. 1, 2, and 3. The sensor system for motion control of a moving unit shown in FIG. 1 is a system configuration where an acceleration sensor is installed on the right wheel of the front wheel drive car indicated in FIG. 18 given as an example of conventional arrangement.

Arrows indicating directions of fore-and-aft, right-left, and top-bottom are defined taking the car body as the reference point. Hereinafter, the same definition of the directions fore-and-aft, right-left, and top-bottom is applied also to the explanation of other embodiment of the present invention.

In this embodiment, an acceleration sensor head 121 having a built-in acceleration sensor, which is a physical value sensor, is installed in the unsprung mass of a shock absorber 105, which is a vibration-buffering member. The shock absorber 105 and a spring 107 include the suspension device of the car.

In this embodiment, the acceleration sensor uses the capacitance-change type, which relies on the change in the capacitance between electrodes caused from movement of a weight due to acceleration. However, acceleration sensors relying on other principles are also applicable as an embodiment of the present invention. Such applicable sensors include: a distortion-change detection type that detects distortion of a weight-supporting beam, a semiconductor-capacitor type, a moving gate transistor type, and a device to which silicon crystal anisotropic etching is applied.

The acceleration sensor head 121 is tightly installed in the unsprung mass of the shock absorber 105 (below the spring 107) with a metal fitting or similar fastener. An acceleration sensor head cable 125 connected to the acceleration sensor head 121, which is fixed at the bottom of the shock absorber 105 and on a boundary wall along engine room 106 with slack, is connected to an acceleration signal processing circuit in the engine room (not shown). These two fixed part for the cable are designed to occupy the same position as the fixed part for a cable for wheel speed sensor.

In this embodiment, the acceleration sensor head 121 has three built-in acceleration sensors each of which is a uniaxial physical value sensor having a single detection axis. These three acceleration sensors are built within the acceleration sensor head 121 with their detection axes direction changed so that each of which will severally detect acceleration in the directions of the x-axis, the y-axis, and the z-axis. The detection axes of the acceleration sensor head 121 are defined as shown in FIGS. 1, 2, and 3; that is, the detection axis in the x-axis direction is defined as the xs-axis, in the y-axis is the ys-axis, and in the z-axis is the zs-axis.

Three uniaxial acceleration sensors built-in the acceleration sensor head 121 are installed on the shock absorber 105 so that each of the xs-axis, the ys-axis, and the zs-axis thereof will satisfy the conditions given below.

The conditions are as follows:

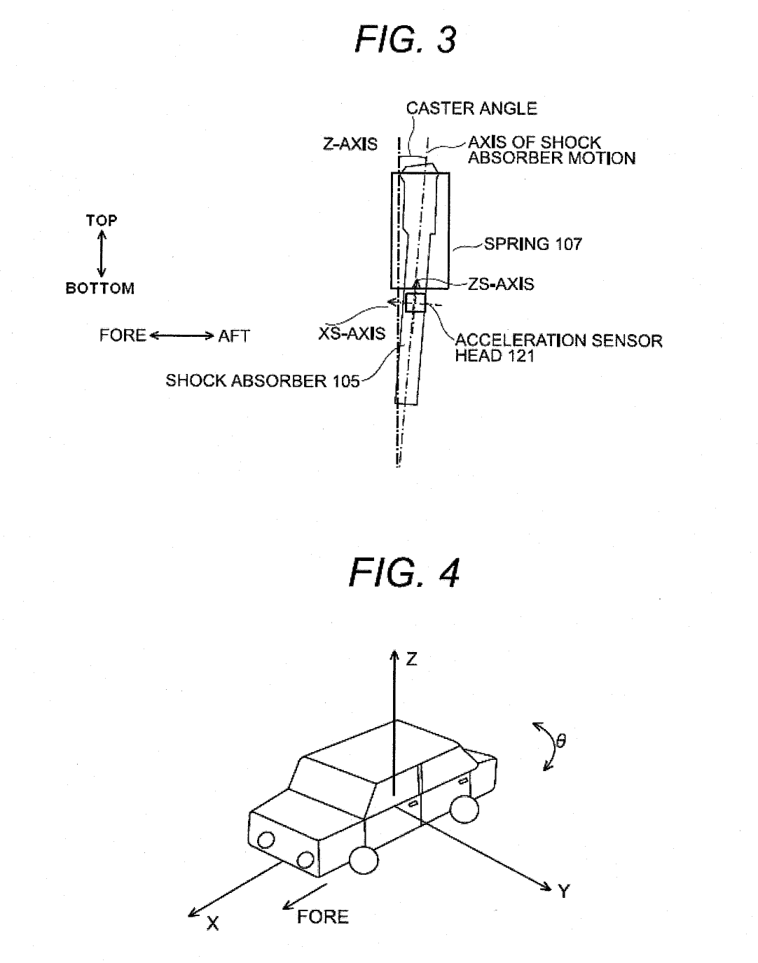

The zs-axis of the acceleration sensor head 121 should be placed in parallel with the axis of the shock absorber 105 motion as shown in FIGS. 1 and 3 with such an orientation that an upward acceleration, when occurred, will cause a signal output of positive polarity.

The xs-axis of the acceleration sensor head 121 should be placed in parallel with the fore-and-aft direction of the car body as shown in FIGS. 2 and 3 in such an orientation that a forward acceleration, when occurred, will cause a signal output of positive polarity.

The ys-axis of the acceleration sensor head 121 should be placed in parallel with the right-left direction of the car body as shown in FIGS. 2 and 3 in such an orientation that a leftward acceleration, when occurred, will cause a signal output of positive polarity.

The explanation of the embodiment 1 of the present invention provided up to this point took the right-side front wheel of the car as an explanatory configuration. When the acceleration sensor head 121 is to be installed on the other wheel of the car, the same manner as explained above is applicable. That is, although the axis of the shock absorber 105 motion differs in each wheel, it satisfies the required conditions to install the acceleration sensors so that the zs-axes of the sensors will be severally in parallel with the axis of the shock absorber 105 motion on the corresponding wheel.

The following explains the principle of the present invention with reference to the embodiment 1 of the present invention.

FIG. 4 shows the definition of the coordinate used in the description of the present invention. In the present invention as FIG. 4 shows, the fore-and-aft direction is defined as the x-axis, the right-left direction the y-axis, and the top-bottom direction the z-axis, taking a car body being in the sprung mass of the car as the reference point of the coordinate. As regards the direction of each axis, the frontward direction of the car body is defined as the positive direction of the x-axis, the leftward direction the positive direction of the y-axis, and the upward direction the positive direction of the z-axis.

Before entering the explanation on the principle of the present invention, the result of an analysis of variations of acceleration due to movements of a car is provided hereunder as a comparative example. The result indicates how the detected acceleration value varies depending on the movement of the car for the range of change of the camber angle caused by a movement of the car such as turning when the acceleration sensor head 121 is installed with its detection axes overlapping the directions of the x-axis, the y-axis, and the z-axis defined based on the car body.

Where the moving unit is assumed to be a passenger car, the maximum acceleration occurring on its body is estimated to be approximately 40 m/s² in the fore-and-aft direction (x-axis direction), approximately 15 m/s² in the right-left direction (y-axis direction), and approximately 40 m/s² in the top-bottom direction (z-axis direction).

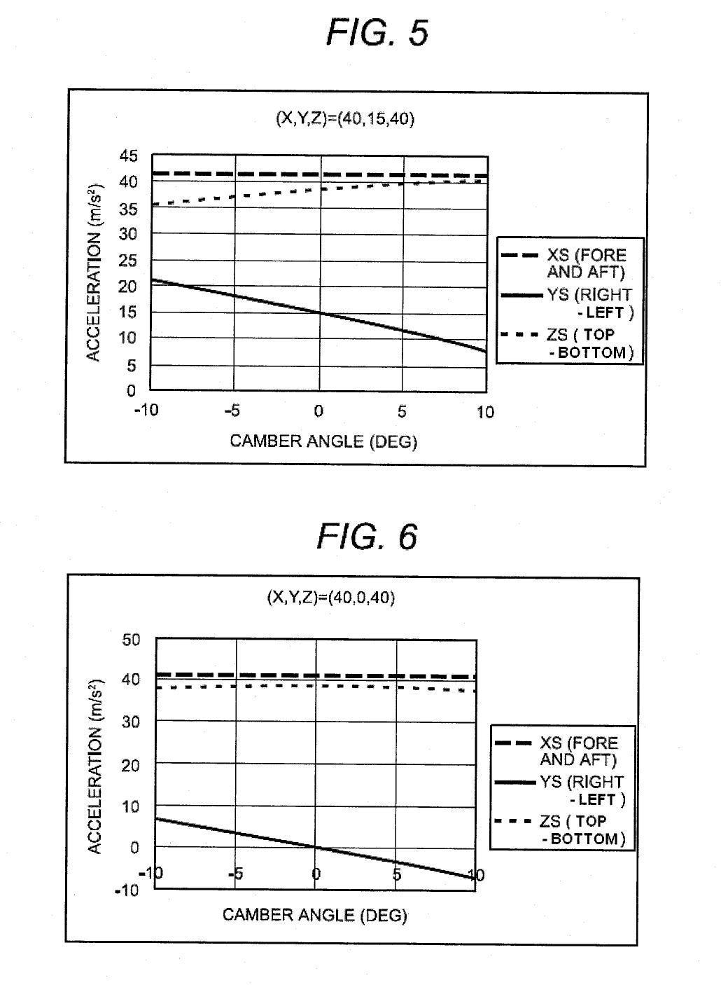

FIG. 5 shows evaluation results of the output variation of the acceleration sensor for the range of the camber angle variation of ±10-degree that turning or other car movement would cause when the expected-maximum acceleration occurs on every x-axis, y-axis, and z-axis of the car body. As can be known from the figure, the output of the acceleration sensor in the xs-axis direction is an as-inputted acceleration value of 40 m/s² irrespectively of the camber angle change. In contrast, the output in the yz-axis direction varies as large as 8 to 22 m/s² and in the zs-axis direction varies 37 to 42 m/s².

FIG. 6 shows another evaluation results of the output variation when an acceleration of 40 m/s², which is the estimated maximum, occurs in the x-axis direction and the z-axis direction of the car body with zero acceleration in the y-axis direction. As can be known from FIG. 6, the outputted acceleration on the ys-axis is ±7 m/s², which is approximately 47% of the estimated maximum acceleration of 15 m/s² in the y-axis direction of the car body, even though the inputted acceleration on the y-axis is zero.

These can be explained by the principle of the present invention as stated below.

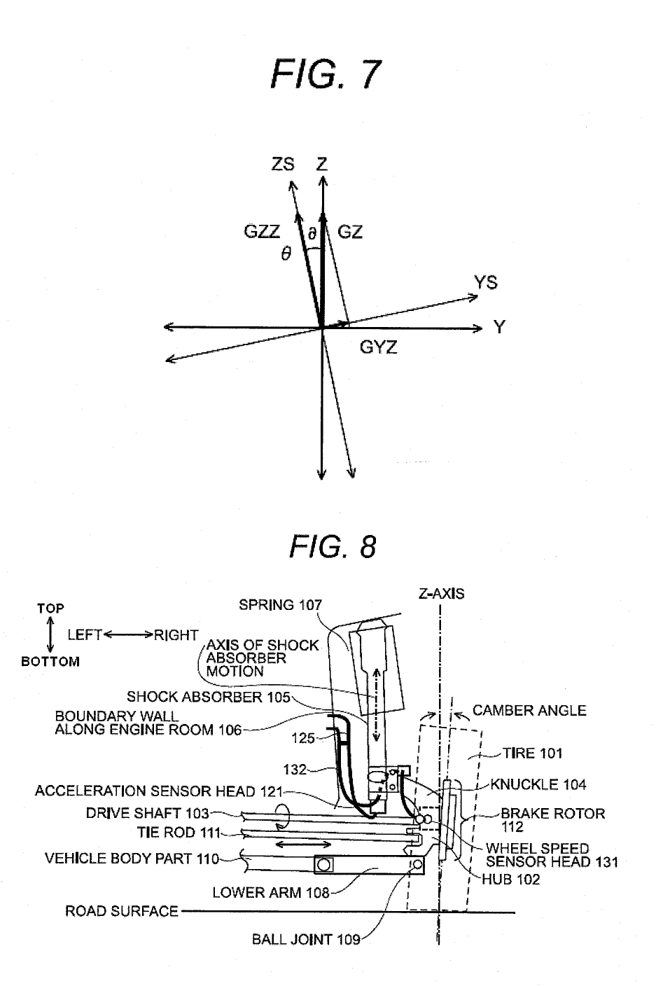

FIG. 7 is an explanatory diagram, which shows the influence of the detection axis of an acceleration sensor, i.e., a physical value sensor, to explain the principle of the present invention. In FIG. 7, the characters x, y, and z respectively represent the x-axis, the y-axis, and the z-axis taking the car body as the reference point; and the characters xs, ys, and zs respectively represent the xs-axis, the ys-axis, and the zs-axis that are the detection axes of the acceleration sensors.

In the explanation of the principle of the present invention, definitions of following physical values are introduced to facilitate the deliberation of such a case that the detection axis of an acceleration sensor, which is a physical value sensor, differs from the x-y-z coordinate defined taking the car body as the reference point.
Gz: An acceleration impressed on the wheel of a car in the z-axis direction (top-bottom direction)
θ: An angle of rotation of the coordinate of the securing portion of an acceleration sensor on the y-z plane (vertical plane)
   In this deliberation, the detection axes of the acceleration sensor, the ys-axis and the zs-axis, have a rotation around the common origin by an angle of θ to the y-z coordinate defined based on the car body as FIG. 7 shows.

Therefore, when the acceleration Gz is impressed on the wheel in the direction of the z-axis, the acceleration sensor detects an acceleration value Gzz on the zs-axis and an acceleration value Gyz on the ys-axis, as shown in FIG. 7. The definition of Gzz and Gyz is as follows:

Gzz=Gz×cos θ Eq. (1)

Gyz=Gz×sin θ Eq. (2)

Gzz is an acceleration detected on the zs-axis of the acceleration sensor caused by the acceleration Gz impressed on the wheel in the direction of the z-axis.
Gyz is an acceleration detected on the ys-axis of the acceleration sensor caused by the acceleration Gz impressed on the wheel in the direction of the z-axis.

Let us define the ratio of Gyz to Gz as αGy and Gzz to Gz as αGz. αGy is the ratio of the acceleration detected because of Gz, which is the acceleration in the top-bottom (z-axis) direction, to the acceleration detected on the ys-axis, on which axis the acceleration sensor is to detect the acceleration in the right-left (y-axis) direction.

αGz is the ratio of the acceleration detected on the zs-axis, on which axis the acceleration sensor is to detect the acceleration in the top-bottom (z-axis) direction, to Gz, which is the acceleration actually impressed on the wheel in the top-bottom (z-axis) direction.

αGy and αGz are obtained from the equations (3) and (4):

αGy=Gyz/Gz×100=sin θ×100(%) Eq. (3)

αGz=(1−Gzz/Gz)×100=(1−cos θ)×100(%) Eq. (4)

As the equations (3) and (4) teach, αGy varies by ±17% and αGz varies by ±2% when the camber angle varies ±10-degree due to turning or other movements of the car body.

Where the moving unit is assumed to be a passenger car, the maximum acceleration occurring on its body is estimated to be 40 m/s² in the x-axis direction (fore-and-aft direction), 15 m/s² in the y-axis direction (right-left direction), and 40 m/s² in the z-axis direction (top-bottom direction). Looking into the acceleration of 40 m/s² in the z-axis direction (top-bottom direction) among these acceleration values teaches that the acceleration to be detected in the zs-axis direction Gzz is:

Gzz=Gz×cos θ=40×cos 10°=39 m/s²;

and that the mingled portion Gyz in the acceleration in the x-axis direction with the acceleration in the ys-axis direction is:

Gyz=Gz×sin θ=40×sin 10°=7 m/s².

This result is consistent with the analysis given in FIGS. 5 and 6. This means that, when the detection axis of the acceleration sensor rotates in terms of the coordinate based on the car body, particularly, on the y-z plane defined on the car body-based coordinate, a large error will be involved in the acceleration value detected by the acceleration sensor.

As shown in FIG. 6, the magnitude of the acceleration in the z-axis direction Gyz=7 m/s² that mingles with the ys-axis direction of the acceleration sensor is as large as 47% of the estimated maximum acceleration of 15 m/s² in the y-axis direction. This does not permit a correct measurement of the y-axis direction acceleration.

The above-stated analysis teaches as follows:

When the effect of the variation of the camber angle due to turning or other movements of the car is taken into account, the full-scale of the acceleration sensor in the ys-axis direction should be designed, in consideration of a mingling from the z-axis direction of the car body, to be as large as ±22 m/s² (=Maximum right-left acceleration of ±15 m/s²+Mingled portion coming from the z-axis direction of the car body ±7 m/s²=±22 m/s²) in preparation for the maximum right-left acceleration of ±15 m/s² that is estimated likely to occur on the car body. Otherwise, the sensor will possibly saturate.

The accuracy of an acceleration sensor is determined generally by the ratio to its full-scale. Therefore, when the full-scale is designed wider, the accuracy of the measuring (corresponds to the magnitude of noise) deteriorates depending on the extent of the widening. A calculation based on above stated ratio tells that the full-scale and the noise become approximately 1.5 times (=22/15).

In contrast, taking account of the tilt θ lowers the signal to be measured in terms of the acceleration in the zs-axis direction of the sensor by ±2% to the acceleration in the z-axis direction Gz.

The increase of noise to 1.5 times with the reduction of signal by 2% causes the signal to noise ratio (S/N) of the acceleration measuring to lower to 65% (=(100−2)/1.5) of the case without occurrence of such phenomenon.

Thus, the variation of the angle of the fixing axis of the acceleration sensor on the y-z plane to the z-axis direction leads to a poor S/N in the acceleration measuring.

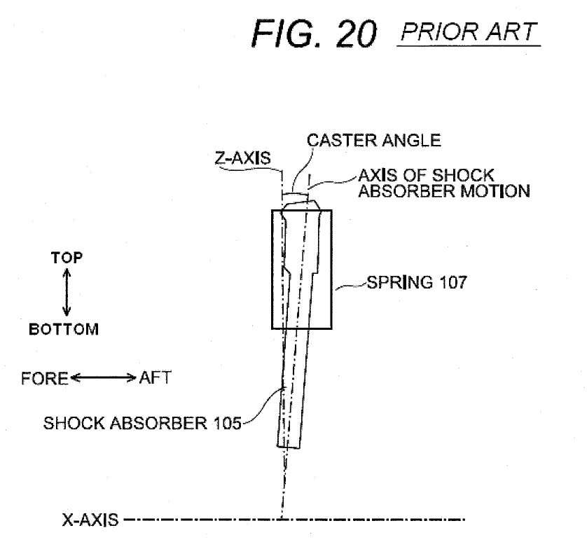

The analysis stated above discussed the angular variation of the detection axis of the acceleration sensor only in the right-left direction to the top-bottom direction of the car body. Further to the above however, the S/N in the acceleration measuring in the right-left direction will further deteriorate because of a possible variation of the tilt of the car body coordinate axis and the detection axis of the acceleration sensor. Such tilt variation is attributable also to the movement of the car, which causes the variation of the caster angle, i.e., a tilt angle in the fore-and-aft direction of the shock absorber that joins the wheel with the unsprung mass as shown in FIG. 20, and the variation of the tilt of the car body and parts in the unsprung mass due to the lean of the car body itself in lateral or longitudinal direction.

For example, when the camber angle varies in response to the reactive force received from the road surface, the angle of the shock absorber viewed from the front varies in the same direction as the camber angle varies since the shock absorber is integrated in one body with the knuckle of the wheel holding portion.

Further for example, when a reactive force from the road surface is impressed on the wheel in the top-bottom direction, the shock absorber not only makes a telescopic motion along its working axis but also moves more or less in directions other than the working axis because of the effect of the compliance (deformation) of such as fixing portions of the suspension device. The direction of the working axis of the shock absorber varies also due to the variation of the tilt of the car body itself in the lateral or longitudinal direction.

As seen from the above, the orientation of the detection axis of the acceleration sensor, the xs-axis, the ys-axis, and the zs-axis, vary depending on the variation of the camber angle or the reactive force on the wheel in the top-bottom direction received from the road surface.

In consideration of these features, the acceleration sensor head 121 is arranged in the present invention so that its zs-axis, which is the detection axis thereof in the z-axis direction, will be in parallel with the axis of the shock absorber 105 motion as described in the embodiment 1. Consequently, the acceleration in the direction of the axis of the shock absorber 105 motion coincides with the zs-axis direction of the acceleration sensor head 121.

Because of this arrangement, the variation of the camber angle due to the turning or other movement of the car does not cause any angular variation in the directions of both the axis of the shock absorber 105 motion and the zs-axis of the acceleration sensor. Therefore, the acceleration along the zs-axis can be accurately measured. Further, influences on the acceleration along the yz-axis or the xs-axis are hardly observed.

As stated above in this embodiment, the acceleration sensor head 121 is capable of accurately detecting the acceleration along the xs-axis, the ys-axis, and the zs-axis directions that occur when the reactive force is received from the road surface caused from movement of the car.

The following is another effect of this embodiment. The acceleration sensor is installed in the position comparatively apart from the bottom portion of the shock absorber 105 (the lower part of the spring 107) and from a brake rotor 112 that becomes hot. Therefore, environmental temperature around the sensor is lower than the temperature of a hub 102 on which a wheel speed sensor is usually installed. Accordingly, these features are advantageous in costs and performances because it is not necessary to use such an acceleration sensor as is usable up to higher temperatures.

The descriptions to here for explanation of this embodiment has employed the acceleration sensor head 121 as is comprised of three built-in uniaxial acceleration sensors having three detection axes: the xs-axis, the ys-axis, and the zs-axis. This embodiment however may use, as its acceleration sensor head, any one of or any combination of: a uniaxial acceleration sensor head that detects the acceleration in the zs-axis direction; a uniaxial acceleration sensor head that detects the acceleration in the ys-axis direction; and a uniaxial acceleration sensor head that detects the acceleration in the xs-axis direction.

For example, when the system is to be applied to ABS system or TCS system, installing only two sensor heads, one on the zs-axis for estimation of the variation of load in the z-axis direction of the car body and the other on the xs-axis that relates to the movement in the x-axis direction of the car body, may be acceptable; because it is enough for these systems to sense the load on the wheel and its movement in the fore-and-aft direction. When applying to the ESC system, installing only on the ys-axis can be a practicable configuration because sensing only lateral acceleration is essential.

Further, this embodiment permits a use of a multi-axial acceleration sensor as a physical value sensor having a plurality of detection axes being at right angles to each other. The multi-axial acceleration sensor is installed on the shock absorber 105 that is a vibration-buffering member in structural elements of the suspension device of a moving unit.

In this configuration, the zs-axis, which is one of the detection axes of the multi-axial acceleration sensor, is oriented to be in approximately parallel with the axis of the shock absorber 105 motion that is a vibration-buffering member in structural elements of the suspension device of a moving unit.

A second embodiment of the present invention will be explained with reference to FIG. 8. This embodiment selects the distal end of a shock absorber 105, which is a vibration-buffering member, as the place of installing an acceleration sensor head 121.

In this embodiment, the acceleration sensor head 121 having a built-in acceleration sensor, which is a physical value sensor, is rigidly held at the distal end of the shock absorber 105, which is a vibration-buffering member.

The acceleration sensor head 121 used in this embodiment has, similarly to the first embodiment, three built-in uniaxial acceleration sensors each with one detection axis. These three acceleration sensors are built within the acceleration sensor head 121 with their detection axes direction changed so that each of which will severally detect acceleration in the directions of the x-axis, the y-axis, and the z-axis.

In this embodiment, the acceleration sensor head 121 is rigidly held at the distal end of the shock absorber 105 so that each of the xs-axis, the ys-axis, and the zs-axis of the acceleration sensor head 121 will satisfy the conditions given below.

The conditions are as follows:

The zs-axis of the acceleration sensor head 121 should be placed in parallel with the axis of the shock absorber 105 motion with such an orientation that an upward acceleration, when occurred, will cause a signal output of positive polarity.

The xs-axis of the acceleration sensor head 121 should be placed in parallel with the fore-and-aft direction of the car body with such an orientation that a forward acceleration, when occurred, will cause a signal output of positive polarity.

The ys-axis of the acceleration sensor head 121 should be placed in parallel with the right-left direction of the car body with such an orientation that a leftward acceleration, when occurred, will cause a signal output of positive polarity.

A comparison of this mode with the first embodiment teaches that the temperature rise around the fixing portion of the acceleration sensor head 121 due to heat generated from a brake rotor 112 is smaller than that in the first embodiment because of the convective flow generated by the installation position of the acceleration sensor head 121 being low.

On the other hand, such configuration brings the installation position of the acceleration sensor head 121 close to the road surface, which invites increased possibility of an acceleration sensor head cable 125 being caught by an object on the road.

However, where the structural design of a car can avoid the catching of the acceleration sensor head cable 125 by an object on the road, the arrangement as shown in this embodiment is still advantages in that a low cost can be achieved by using such a sensor as has a low operational maximum temperature, or a use of a high-performance sensor, of which operational maximum temperature is designed low, will become practicable within an allotted cost-budget.

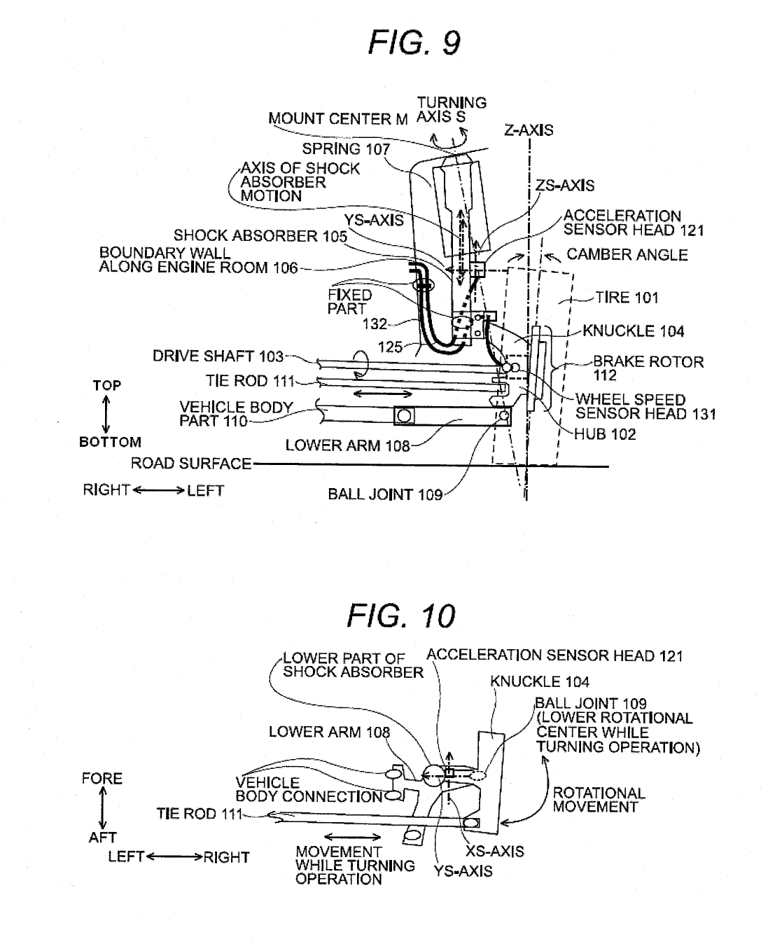

A third embodiment of the present invention is shown in FIGS. 9 and 10. In this embodiment, the xs-axis and the ys-axis in the detection axes of an acceleration sensor head 121 installed on a shock absorber 105 are oriented so as to intersect a turning axis S, which is the manipulation axis of the moving unit, on the plane common to them.

With such configuration in this embodiment, the steering of the wheel does not produce, on the acceleration detection axis, any acceleration in the steering-oriented turning direction produced by the angular acceleration resulted from steering. Therefore, the acceleration in the zs-axis and ys-axis directions can be detected without disturbance by the steering movement.

The acceleration sensor head 121 used in this embodiment has, similarly to the first embodiment, three built-in uniaxial acceleration sensors each having a single detection axis. These three acceleration sensors are built within the acceleration sensor head 121 with their detection axes direction changed so that each of which will severally detect acceleration in the directions of the x-axis, the y-axis, and the z-axis.

In this embodiment, the acceleration sensor head 121 is installed on the shock absorber 105 so that each of the xs-axis, the ys-axis, and the zs-axis of the acceleration sensor head 121 will satisfy the conditions given below.

The conditions are as follows:

The zs-axis of the acceleration sensor head 121 should be placed in parallel with the axis of the shock absorber 105 motion with such an orientation that an upward acceleration, when occurred, will cause a signal output of positive polarity.

The xs-axis of the acceleration sensor head 121 should be placed in parallel with the fore-and-aft direction of the car body with such an orientation that a forward acceleration, when occurred, will cause a signal output of positive polarity. The ys-axis of the acceleration sensor head 121 should be placed in parallel with the right-left direction of the car body with such an orientation that a leftward acceleration, when occurred, will cause a signal output of positive polarity.

Further, in this embodiment, the xs-axis and the ys-axis are oriented so as to intersect the turning axis S, which is the manipulation axis of the moving unit, on the plane common to them.

When the acceleration sensor head is to be installed on the other wheel, sensors can be installed in the same manner as explained above. However, the non-steering wheel does not demand to consider such requirements on the steering axis.

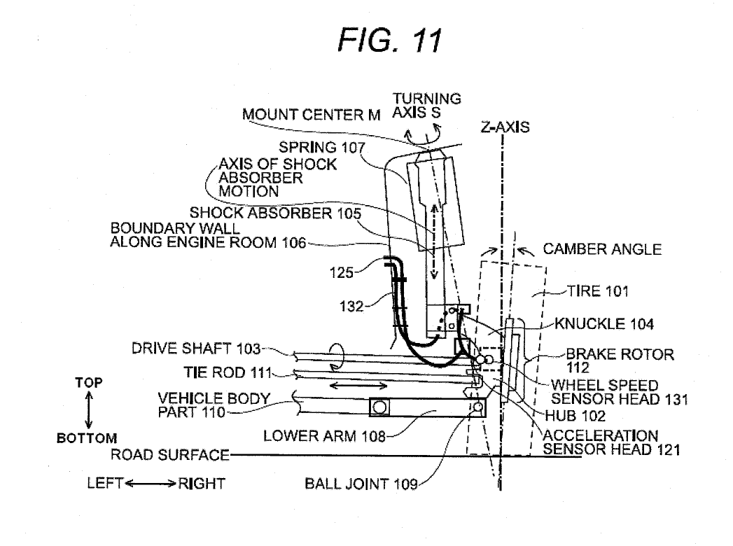

A fourth embodiment of the present invention is shown in FIG. 11. This embodiment selects the bottom portion of a knuckle 104 as the place of installing an acceleration sensor head 121.

The acceleration sensor head 121 used in this embodiment has, similarly to the first embodiment, three built-in uniaxial acceleration sensors each having a single detection axis. These three acceleration sensors are built within the acceleration sensor head 121 with their detection axes direction changed so that each of which will severally detect acceleration in the directions of the x-axis, the y-axis, and the z-axis.

In this embodiment, the acceleration sensor head 121 is installed on the knuckle 104 so that each of the xs-axis, the ys-axis, and the zs-axis of the acceleration sensor head 121 will satisfy the conditions given below.

The conditions are as follows:

The zs-axis of the acceleration sensor head 121 should be placed in parallel with the axis of a shock absorber 105 motion with such an orientation that an upward acceleration, when occurred, will cause a signal output of positive polarity.

The xs-axis of the acceleration sensor head 121 should be placed in parallel with the fore-and-aft direction of the car body with such an orientation that a forward acceleration, when occurred, will cause a signal output of positive polarity.

The ys-axis of the acceleration sensor head 121 should be placed in parallel with the right-left direction of the car body with such an orientation that a leftward acceleration, when occurred, will cause a signal output of positive polarity.

Compared with the third embodiment, the installation position of the acceleration sensor head 121 is closer to a brake rotor 112 but is lower in the height from the road surface in this embodiment. Therefore, taking account of the possible effect of the convective flow permits the structural design of the car to bring the environmental temperature around the installation part of the acceleration sensor head 121 to a comparable level to or lower than that of the brake rotor 112.

In this embodiment, such configuration brings, similarly to the second embodiment, the installation position of the acceleration sensor head cable 125 is close to the road surface, which invites increased possibility of an acceleration sensor head cable 125 being caught by an object on the road. However, where the structural design of a car can avoid such problem, the arrangement in this embodiment as shown in FIG. 11 has advantages in that a low cost can be achieved by using such a sensor as has a low operational maximum temperature, or a use of a high-performance sensor, of which operational maximum temperature is designed low, will become practicable within an allotted cost-budget.

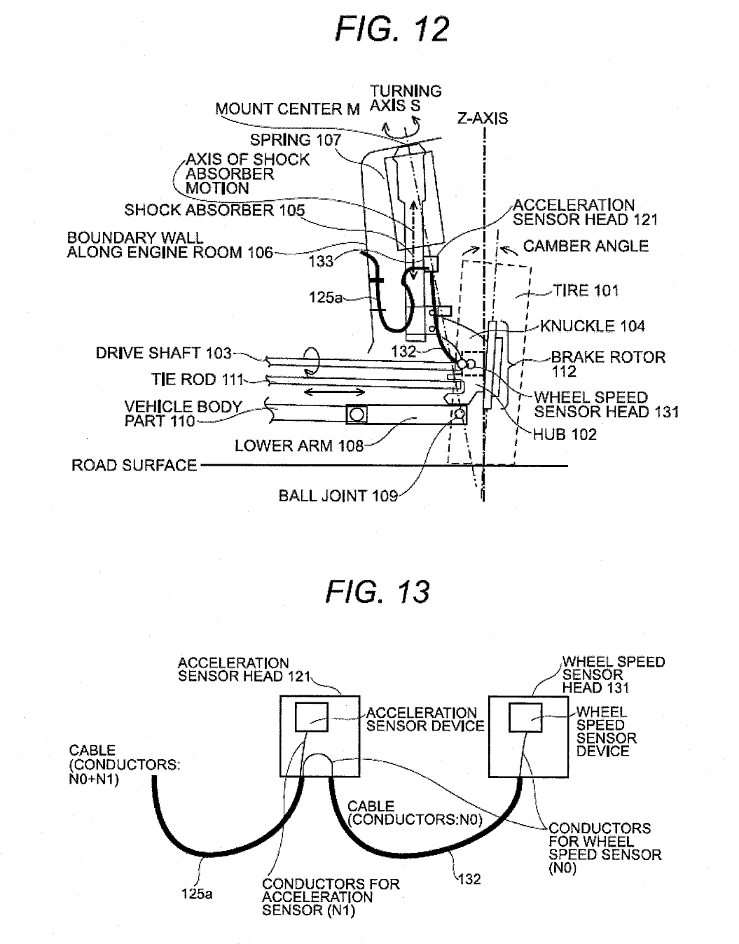

A fifth embodiment of the present invention is shown in FIG. 12. In this embodiment, an acceleration sensor head 121 is arranged at an intermediary location somewhere on a wheel speed sensor head cable 132 and is then installed on a fixing portion of wheel speed sensor head cable 133.

Such configuration in this embodiment permits a shared use of the fixing part for the acceleration sensor head 121 with the fixing part for the wheel speed sensor head cable 132 and, further, the cable can be jointly used also by a wheel speed sensor head 131.

By this configuration, the cables in the unsprung mass can be unified into one reducing the cabling space with weight and material cost for cables and fixing devices reduced.

Further, this configuration further permits two sensor heads, one the wheel speed sensor head 131 and the other the acceleration sensor head 121, to be pre-assembled into a wire harness with one cable in which they are connected at their heads with soldering or welding their conductors. This offers man-hour reduction in the car assembling.

FIG. 13 explains a configuration of one-bodied structure in this embodiment in which the acceleration sensor head 121 is arranged at an intermediary location somewhere on the wheel speed sensor head cable 132.

In this embodiment, the wheel speed sensor head 131 and the acceleration sensor head 121, which has a built-in acceleration sensor as a physical value sensor, are connected by a series of cables.

As FIG. 13 shows, the number of conductors used for the wheel speed sensor head 131 is N₀ and for the acceleration sensor head 121 is N₁, the number of the conductor of the wheel speed sensor head cable 132 that connects the wheel speed sensor head 131 with the acceleration sensor head 121 is N₀.

For the cable to connect the acceleration sensor head 121 to an electronic circuit in the engine room, an acceleration sensor head cable 125a is used, wherein the number of conductors thereof is made to have the sum of the number of conductors of the wheel speed sensor head cable 132, N₀, and of the acceleration sensor head 121, N₁: that is N₀+N₁.

The acceleration sensor head cable 125a is relayed at the acceleration sensor head 121 and the wheel speed sensor head cable 132 is connected to the wheel speed sensor head 131. That is, the acceleration sensor head 121 relays the conductors for the wheel speed sensor head 131.

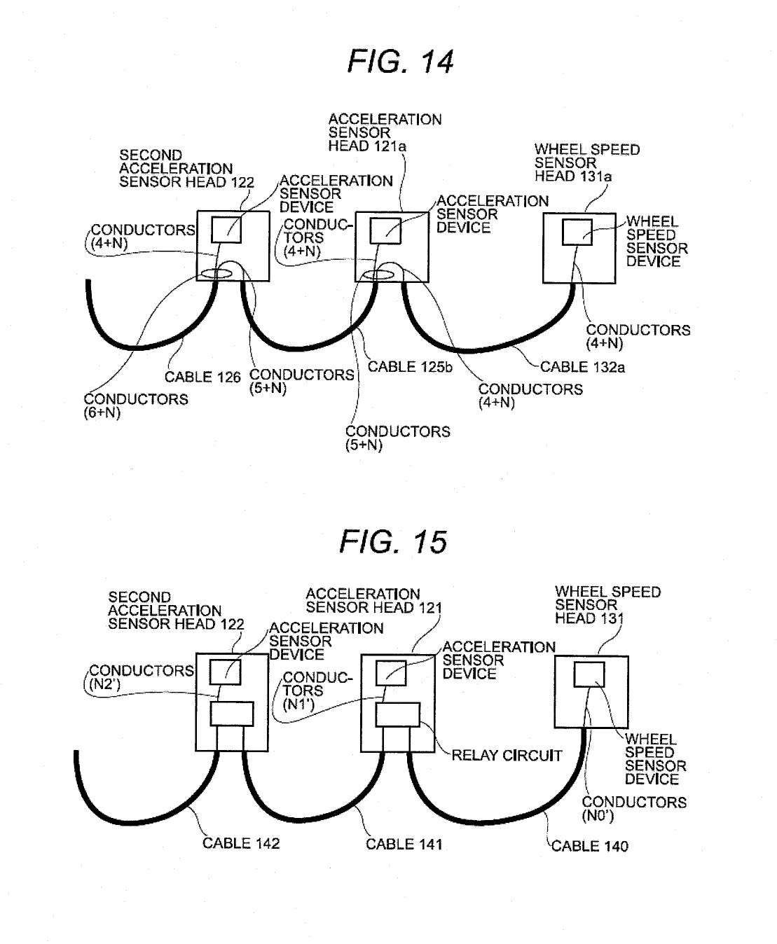

FIG. 14 shows another configuration of the wire harness of one-bodied structure used in this embodiment.

As FIG. 14 shows, an acceleration sensor head 121a and a wheel speed sensor head 131a, both are to the Serial Peripheral Interface (SPI) specification, are used as the element respectively in the acceleration sensor head 121 and the wheel speed sensor head 131.

This configuration is for such a case as uses two acceleration sensor heads, wherein the acceleration sensor head 121a and, with addition of another acceleration sensor head, a second acceleration sensor head 122 are incorporated.

With the interface according to SPI specification, the number of conductors of 3+the number of sensors+N (the number of power source wires) is enough to satisfy the requirement of a system that uses plural elements. This means that, on the left side of the second acceleration sensor head 122 in the figure, the number of conductors of an acceleration sensor head cable 126 connected to the second acceleration sensor head cable 122 is 6+N, since signals for three physical value sensors are handled therein.

The number of conductors of an acceleration sensor head cable 125b provided between the second acceleration sensor head 122 and the acceleration sensor head 121a is 5+N, since signals for two physical value sensors are handled therein.

The number of conductors of a wheel speed sensor head cable 132a provided between the acceleration sensor head 121a and the wheel speed sensor 131a is 4+N, since signal for one physical value sensors is handled therein.

As stated above, there is a possibility in that the number of conductors can be reduced more than that in the configuration shown in FIG. 13 in the case where the number of the sensing heads incorporated in a system is large.

FIG. 15 shows another configuration of the wire harness of one-bodied structure in this embodiment.

As FIG. 15 shows, a relay circuit is provided on a sensor head placed at an intermediary location to relay the sensor information coming from sensors located on the far side thereof by multiplexing. In this case, the number of the conductors of cables 142 and 141 can be made same.

Other method of relaying signals (or relaying conductors) in handling plural sensors than the above may be found available; therefore, an optional selection of relaying method is practicable based on the evaluation on the advantage and disadvantage of each method.

In the above configuration, the number of the sensor heads on one series of cable was one to three. The idea of above-explained configuration is, however, applicable in a similar manner to a system having four or more sensing heads.

Any connection order over plural sensors with a series of cables is acceptable; a connection order determined from the viewpoint of assembling productivity may be a practical method. A sensing head having a built-in sensor other than an acceleration sensor is also acceptable.

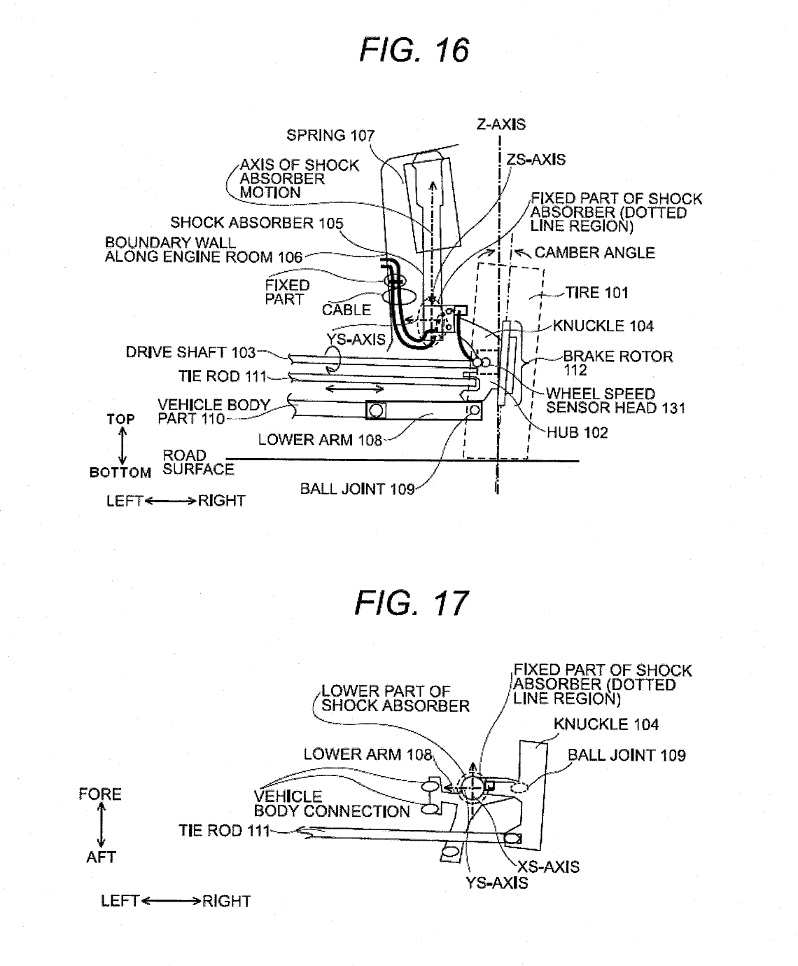

A sixth embodiment of the present invention is shown in FIGS. 16 and 17.

In this embodiment, the physical value sensor may be a load sensor that detects a physical value other than acceleration for example a force (a load) working on parts arranged in the unsprung mass. In this case, as shown in FIGS. 16 and 17, the reactive force that works on parts in the unsprung mass coming from the road surface can be detected by sensing stress appearing on the fixing part in the bottom area of a shock absorber 105 or on the non-rotating portion of a hub 102.

The present invention is applicable also to moving bodies other than four-wheel automobiles when they are those kinds of moving bodies that have suspension devices such as, for example, two-wheel automobiles and robots.

Using the output from an acceleration sensor or other similar sensor installed in the above-stated manner in a motion control of automobiles (such as ESC, ABS, and TCS) enables the motion control to work with an increased accuracy more than that in the conventional control system, because the detection-desired acceleration can be accurately detected separately from acceleration on other detection axes.

It will be obvious to those having skill in the art that many changes may be made in the above-described details of the preferred embodiments of the present invention. The scope of the present invention, therefore, should be determined by the following claims.

1. A sensor system for motion control of a moving unit, comprising:
an uniaxial physical value sensor having a single detection axis, and
said uniaxial physical value sensor being installed in an unsprung mass of a suspension device provided in said moving unit,
wherein said detection axis of said uniaxial physical value sensor and an axis of a vibration-buffering member motion provided on said suspension device are approximately in parallel.

2. A sensor system for motion control of a moving unit, comprising:
a multi-axial physical value sensor comprising a plurality of detection axes intersecting alternately at right angles, and
said multi-axial physical value sensor being installed in an unsprung mass of a suspension device provided in said moving unit,
wherein one detection axis of said multi-axial physical value sensor and an axis of a vibration-buffering member motion provided on said suspension device are arranged in approximately parallel; and
the other detection axes of said multi-axial physical value sensor are oriented so as to intersect the axis of a vibration-buffering member motion provided on said suspension device at approximately right angles.

3. The sensor system for motion control of a moving unit according to claim 1, wherein said physical value sensor is installed in the unsprung mass of said vibration-buffering member.

4. The sensor system for motion control of a moving unit according to claim 2, wherein said physical value sensor is installed in the unsprung mass of said vibration-buffering member.

5. The sensor system for motion control of a moving unit according to claim 1, wherein said physical value sensor is held rigidly at a distal end of said vibration-buffering member.

6. The sensor system for motion control of a moving unit according to claim 2, wherein said physical value sensor is held rigidly at a distal end of said vibration-buffering member.

7. The sensor system for motion control of a moving unit according to claim 1, wherein said physical value sensor is installed on said vibration-buffering member so that its detection axis intersects a manipulation axis of said moving unit.

8. The sensor system for motion control of a moving unit according to claim 2, wherein said physical value sensor is installed on said vibration-buffering member so that its detection axis intersects a manipulation axis of said moving unit.

9. The sensor system for motion control of a moving unit according to claim 1, wherein a plurality of said physical value sensors are installed on said moving unit,
a cable provided on each of said plural physical value sensors is held on a holder provided on said vibration-buffering member, and
other physical value sensors are rigidly held by said holder.

10. The sensor system for motion control of a moving unit according to claim 2, wherein a plurality of said physical value sensors are installed on said moving unit,
a cable provided on each of said plural physical value sensors is held on a holder provided on said vibration-buffering member, and
other physical value sensors are rigidly held by said holder.

11. The sensor system for motion control of a moving unit according to claim 1, wherein a plurality of said physical value sensors are installed on said moving unit and said plural physical value sensors are connected by a series of cables.

12. The sensor system for motion control of a moving unit according to claim 2, wherein a plurality of said physical value sensors are installed on said moving unit and said plural physical value sensors are connected by a series of cables.

13. The sensor system for motion control of a moving unit according to claim 1, wherein
said moving unit is a vehicle;
a wheel speed sensor is provided on a wheel of said vehicle for detection of the revolution number of said wheel;
a cable provided on said wheel speed sensor is held on a holder provided on said vibration-buffering member; and
said physical value sensor is rigidly held on said holder.

14. The sensor system for motion control of a moving unit according to claim 2, wherein
said moving unit is a vehicle;
a wheel speed sensor is provided on a wheel of said vehicle for detection of the revolution number of said wheel;
a cable provided on said wheel speed sensor is held on a holder provided on said vibration-buffering member; and
said physical value sensor is rigidly held on said holder.

15. The sensor system for motion control of a moving unit according to claim 13, wherein said wheel speed sensor and said physical value sensor are connected by a series of cables.

16. The sensor system for motion control of a moving unit according to claim 14, wherein said wheel speed sensor and said physical value sensor are connected by a series of cables.

17. The sensor system for motion control of a moving unit according to claim 1, wherein said physical value sensor is an acceleration sensor.

18. The sensor system for motion control of a moving unit according to claim 2, wherein said physical value sensor is an acceleration sensor.

19. The sensor system for motion control of a moving unit according to claim 1, wherein said physical value sensor is a load sensor.

20. The sensor system for motion control of a moving unit according to claim 2, wherein said physical value sensor is a load sensor.

21. A method of installing a sensor system for motion control of a moving unit, comprising:
installing an uniaxial physical value sensor, comprising a single detection axis, in an unsprung mass of a suspension device provided in said moving unit, and
arranging the detection axis of said uniaxial physical value sensor and an axis of a vibration-buffering member motion provided on said suspension device in approximately parallel.

22. A method of installing a sensor system for motion control of a moving unit, comprising:
installing a multi-axial physical value sensor, comprising a plurality of detection axes intersecting alternately at right angles, in an unsprung mass of a suspension device provided in said moving unit;
arranging one detection axis of said multi-axial physical value sensor and an axis of a vibration-buffering member motion provided on said suspension device in approximately parallel; and
orienting the other detection axes of said multi-axial physical value sensor so as to intersect the axis of said vibration-buffering member motion provided on said suspension device at approximately right angles.

23. The method of installing a sensor system for motion control of a moving unit according to claim 21, wherein
said physical value sensor is installed in the unsprung mass of said vibration-buffering member.

24. The method of installing a sensor system for motion control of a moving unit according to claim 22, wherein
said physical value sensor is installed in the unsprung mass of said vibration-buffering member.

25. The method of installing a sensor system for motion control of a moving unit according to claim 21, wherein
said physical value sensor is held rigidly at the distal end of said vibration-buffering member.

26. The method of installing a sensor system for motion control of a moving unit according to claim 22, wherein
said physical value sensor is held rigidly at the distal end of said vibration-buffering member.

27. The method of installing a sensor system for motion control of a moving unit according to claim 21, wherein
said physical value sensor is arranged on said vibration-buffering member so that said detection axis of said physical value sensor intersects a manipulation axis of said moving unit.

28. The method of installing a sensor system for motion control of a moving unit according to claim 22, wherein
said physical value sensor is arranged on said vibration-buffering member so that said detection axis of said physical value sensor intersects a manipulation axis of said moving unit.

29. The method of installing a sensor system for motion control of a moving unit according to claim 21, wherein
a plurality of said physical value sensors are installed on said moving unit;
holding a cable provided on each of said plural physical value sensors, which are installed on said moving unit, on a holder provided on said vibration-buffering member;
and holding the other physical value sensors rigidly on said holder.

30. The method of installing a sensor system for motion control of a moving unit according to claim 22, wherein
a plurality of said physical value sensors are installed on said moving unit;
holding a cable provided on each of said plural physical value sensors, which are installed on said moving unit, on a holder provided on said vibration-buffering member;
and holding the other physical value sensors rigidly on said holder.

31. The method of installing a sensor system for motion control of a moving unit according to claim 21, wherein
said moving unit is a vehicle;
installing a wheel speed sensor on a wheel of said vehicle for detection of the revolution number of said wheel of said vehicle;
holding a cable provided on said wheel speed sensor on a holder provided on said vibration-buffering member;
and holding said physical value sensor rigidly on said holder.

32. The method of installing a sensor system for motion control of a moving unit according to claim 22, wherein
said moving unit is a vehicle;
installing a wheel speed sensor on a wheel of said vehicle for detection of the revolution number of said wheel of said vehicle;
holding a cable provided on said wheel speed sensor on a holder provided on said vibration-buffering member;
and holding said physical value sensor rigidly on said holder.
